(19) United States
(12) Patent Application Publication
(10) Pub. No.: US 2014/0097078 A1
(43) Pub. Date: Apr. 10, 2014

(54) DISTILLATION DEVICE AND METHOD

(71) Applicants: Lisa Iddon, Preston (GB); Rajiv Bhalla, Brisbane (AU); ANTHONY Wilson, Waddesdon (GB)

(72) Inventors: Lisa Iddon, Preston (GB); Rajiv Bhalla, Brisbane (AU); ANTHONY Wilson, Waddesdon (GB)

(73) Assignee: GE HEALTHCARE LIMITED, LITTLE CHALFONT (GB)

(21) Appl. No.: 14/124,804

(22) PCT Filed: Jun. 7, 2012
(86) PCT No.: PCT/US2012/041204

§ 371 Date: Dec. 9, 2013

Related U.S. Application Data
(60) Provisional application No. 61/531,212, filed on Sep. 6, 2011.
(60) Provisional application No. 61/494,934, filed on Jun. 9, 2011.

(51) Int. Cl. B01D 3/00

(52) U.S. Cl. CPC B01D 3/009
USPC 203/28; 202/176

(57) ABSTRACT

A click chemistry process to be performed with an automated synthesis device using a synthesis cassette includes the steps of performing a chemical reaction in a first vessel at a first elevated temperature, heating the first vessel to a second elevated temperature to cause distillation, delivering a distilled reaction product from the first vessel to a second vessel, performing a click chemistry reaction with the distilled reaction product in the second vessel, purifying the click chemistry product, and formulating a final product from the purified click chemistry product. A cassette and a kit of parts for performing the process are also provided.

### FIELD OF THE INVENTION

The present invention is relates to radiochemistry. More specifically, the present invention is directed to a device for and method of performing distillation during radiosynthesis.

### BACKGROUND OF THE INVENTION

The prevalence of gastroenteropancreatic neuroendocrine tumors (GEP-NETs) has increased over the last three decades, leading to an increased need for a suitable PET imaging agent. Somatostatin receptors, mainly sub-type 2, have been shown to be over-expressed on the surface of GEP-NETs leading to the development of octreotide, a somatostatin analogue. Octreotide has been labelled with many isotopes, but the radioligand routinely used in the clinic remains to be [¹¹¹In]-Pentetreotide (Octreoscan™, sold by Covidien, manufactured by Mallinckrodt, Inc., Maryland Heights, Mo., USA).

Alternatively, a fluorine-18 labelled octreotate analogue which can be used for positron emission tomography (PET) imaging has also been developed. Octreotate was chosen over octreotide, since improvement in receptor affinity has been shown replacing the threoninol to threonine (see, Reubi, J. C.; Schar, J. C.; Waser, B.; Wenger, S., Eur. J. Nucl. Med. Mol. Imaging 2000, 27, 273). A novel class of fluorine-18 labelled Octreotate analogues have been developed through incorporation of various linker moieties at the N-terminus of the octapeptide. The labelling was achieved via the copper catalysed azide-alkyne cycloaddition reaction (CuAAC), which has proved to be an efficient and selective radiolabelling technique.

[¹⁸F]FET-βAG-TOCA has been identified as a tracer for the imaging of somatostatin positive neuroendocrine tumours (see, Iddon, L.; Leyton, J.; Indrevoll, B.; Glaser, M.; Robins, E. G.; George, A. J. T.; Cuthbertson, A.; Luthra, S. K.; Aboagye, E. O., Bioorg. Med. Chem. Lett. 21, (10), 3122). FET-βAG-TOCA, can be efficiently labelled during a click reaction in five minutes at room temperature. The use of click chemistry as a method to introduce radioisotopes into PET tracers has become more frequent in recent years since it was first applied by Marik and Sutcliffe, see Tetrahedron Lett. 2006, 47, 6681. Click chemistry has the advantage of being selective, and therefore reactive functional groups are well tolerated. It often favours aqueous conditions which allows for more polar molecules such as peptides to be labelled. The reaction shows selectivity, giving only the 1,4-substituted triazole and is generally an efficient reaction done at ambient temperatures.

[¹⁸F]fluoroethyl azide (“[¹⁸F]FEA”), is an intermediate of [¹⁸F]FET-βAG-TOCA. [¹⁸F]FEA may be purified by distillation along with the reaction solvent, acetonitrile. However, the apparatus used to carry out distillation in a manual laboratory setting is the thermospray device developed by the assignee of the instant invention, as described in United States Patent Publication No. 20090312654. The thermospray device is a unit containing a heated, coiled tube of a suitable material (peek tubing, stainless steel) in which the product can be collected through the end of the tubing in an appropriate vial. As this is a manual operation in which high quantities of fluorine-18 (>20 mCi) can lead to high extremity doses, there is a lack in the art for performing the distillation method to purify [¹⁸F]FEA as part of a click chemistry reaction method on an automated platform. There is additionally a need in the art for performing both distillation and click chemistry reactions on an automated platform to be able to isolate levels of activity for a clinical dose (˜10 mCi/mL).

### SUMMARY OF THE INVENTION

The present invention provides a distillation and click chemistry method which can be applied to an automated process. The present invention is able to isolate material which could be suitable for routine clinical imaging of neuroendocrine tumors. The present invention provides a cassette for automated radiosynthesis that incorporates two reaction vessels.

The present invention also provides a disposable synthesis cassette and a method for performing purification and click chemistry on an automated synthesizer. The cassette includes two reaction chambers. The cassette desirably allows for additional purification to take place off-cassette while further performing final formulation prior to dispensing.

The present invention further provides a kit for performing synthesis of a radiopharmaceutical. The kit includes components adapted to be used with an automated synthesizer for performing purification and click chemistry. The kit provides two reaction chambers.

The cassette and kit of the present invention are configurable to be particularly suitable for synthesizing fluorine-18 labelled octreotate analogue synthesized via click chemistry.

The cassette and kit of the present invention additionally allows for preconditioning of an SPE cartridge which may be performed under a hood to maintain sterility of the cassette. The cassette and kit of the present invention also allows for provision of reagents in the second reaction chamber which may be performed under a hood to maintain sterility of the cassette.

The present invention may be used to purify the labelled intermediate, eg, [¹⁸F]FEA, of a synthesized compound in an automated process. The purification may include distillation of the intermediate prior to performing a click chemistry reaction. For example, the present invention is able to provide for the synthesis of FET-βAG-TOCA on an automated cassette-based platform by first distilling [¹⁸F]FEA and providing the distilled output to a click chemistry reaction.

### BRIEF DESCRIPTION OF THE DRAWINGS

FIG. 1 depicts an automated synthesis device to which is attached a cassette of the present invention.

FIG. 2 depicts the manifold and certain of the connections made thereto in a cassette of the present invention.

FIG. 3 depicts a reaction performed by a cassette of the present invention.

### DETAILED DESCRIPTION OF THE PREFERRED EMBODIMENTS

The present invention provides a cassette, and additionally a kit of components, for performing a radiosynthesis method including a purification step via distillation and a cassette which allows this method to be performed in a substantially automated manner. The present invention incorporates two reaction vessels onto a cassette manifold in which to purify an intermediate of the radio synthesis product and to perform a click chemistry reaction. The second vessel added to the cassette allows for a reaction to occur at room temperature.

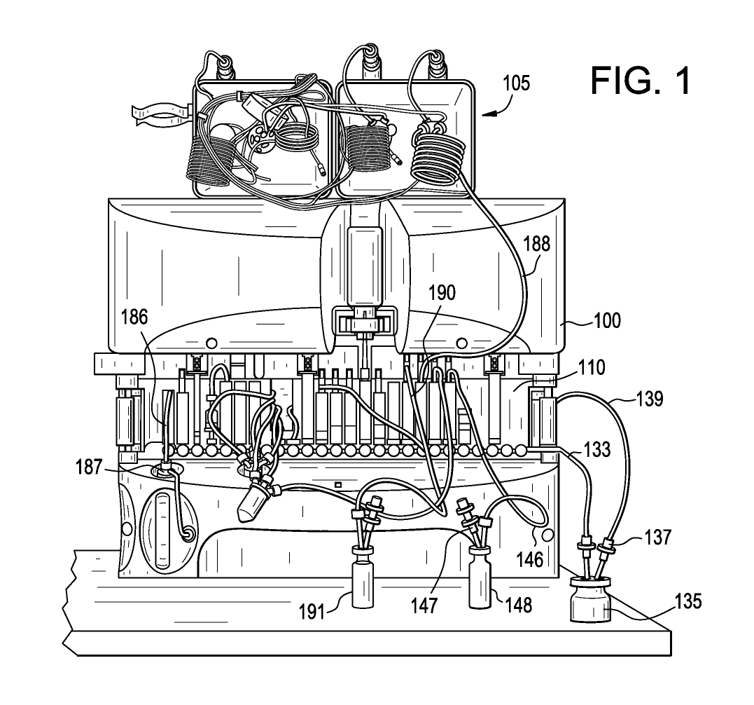

FIG. 1 depicts a synthesis device 100 and a detachably mountable cassette 110 of the present invention. Cassette 110 is desirably a pre-assembled cartridge and is desirably adaptable for synthesizing clinical batches of different radiopharmaceuticals with minimal customer installation and connections. Cassette 110 includes a reaction vessel, a distillation vessel, reagent vials, cartridges, filters, syringes, tubings, and connectors for synthesizing a radiotracer according to the present invention, as will be described hereinbelow. Connections are desirably automatically made to the reagent vials by driving the septums thereof onto penetrating spikes of the cassette so as to allow the synthesizer access to use the reagents.

Synthesis device 100 may be a FASTlab® synthesizer sold by GE Healthcare, Liege, BE, which incorporates the software for operating cassette 110 in accordance with the method of the present invention. The software of the present invention is provided as a non-transitory computer readable storage medium with an executable program for performing the method of the present invention when cassette 110 is mounted to synthesis device 100. Synthesizer 100 is thus able to operate cassette 110 to conduct the steps of performing a chemical reaction in a first vessel at a first elevated temperature, heating the first vessel to a second elevated temperature to cause distillation, delivering a distilled reaction product from the first vessel to a second vessel; and performing a click chemistry reaction with the distilled reaction product in the second vessel. Desirably, the second elevated temperature is higher than the first elevated temperature. Additionally, the first and second vessels are desirably connected to a common manifold through which the reaction product and certain reagents may be conducted during performance of the process. For example, the delivering step desirably includes the step of directing the distilled reaction product from the first vessel though a portion of the manifold to the second vessel. Additionally, the method of the present invention may further include the steps of purifying the click chemistry product and formulating a final product from the purified click chemistry product, wherein the purifying step is performed in a purifying device connected to the manifold. The purifying device is thus desirably operated in coordination with said synthesizer device. The second vessel is desirably preloaded with reagents, although the present invention may include the step of placing click chemistry reagents in the second vessel

Cassette 110 is thus removably attachable to synthesis device 100 which cooperatively engages the cassette so as to be able to actuate each of the stopcocks and syringes to drive a source fluid with a radioisotope through the cassette for performance of a chemical synthesis process. Additionally, synthesis device 100 includes a heating cavity into which receives the first reaction vessel of cassette 110 therein so as provide the heat required for chemical reactions occurring therein. No heating is required for the second vessel. Synthesizer 100 is programmed to operate pumps, syringes, valves, heating element, and controls the provision of nitrogen and application of vacuum to the cassette so as to direct the source fluid into mixing with the reagents, performing the chemical reactions, through the appropriate purification cartridges, and selectively pumping the output tracer and waste fluids into appropriate vial receptacles outside the cassette. While the fluid collected in the output vial is typically input into another system for either purification and/or dispensement, synthesizer 100 and cassette 110 can also be connected to a separate purification system which returns a purified compound back to cassette 110 for further processing.

After product dispensement, the internal components of cassette 110 are typically flushed to remove latent radioactivity from the cassette, although some activity will remain. Cassette 110 thus can be operated to perform a two-step radiosynthesis process. By incorporating a second reaction vessel on the manifold, cassette 110 of the present invention is further able to provide simple purification so as enable click chemistry processes.

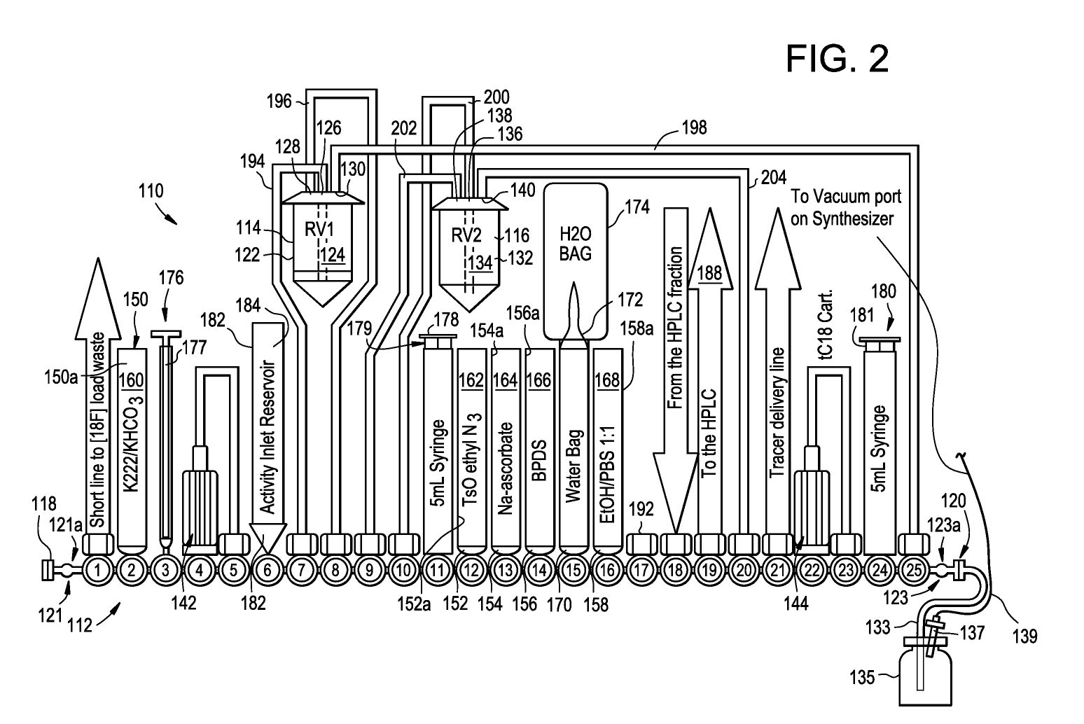

With additional reference to FIG. 2, cassette 110 incorporates a manifold 112 including twenty-five serially-aligned 3way/3position stopcocks valves 1-25, respectively. Manifold valves 1-25 are also referred to as their manifold positions 1-25 respectively. Manifold valves 1, 4-5, 7-10, 17-23, and 25 have female luer connectors projecting up therefrom. Valves 2 and 11-16 have an elongate open vial housing upstanding therefrom and support an upstanding cannula therein for piercing the septum capping an inverted reagent vial inserted in the respective vial housing. Movement of the reagent vial to be pierced by the respective cannula is performed under actuation by the synthesizer device. Valve 6 supports an upstanding elongate open receiver housing for receiving a delivery line from the synthesizer which provides the radioisotope to cassette 110. The delivery line inserted into the housing at valve 6 makes sealed contact with the interior wall of the housing to ensure a sealed flowpath connection between the delivery line and the cassette. Valves 3, 11, and 24 support an elongate open syringe barrel upstanding therefrom.

Valves 2-24 include three open ports opening to adjacent manifold valves and to their respective luer connectors, cannulas, and syringe barrels. Valves 1 and 25 include three open ports, one port opening towards valve 2 and 24, respectively, on port opening upwards, and one port opening in fluid communication with manifold endports 118 and 120, respectively. Each valve includes a rotatable stopcock which puts any two of the three associated ports in fluid communication with each other while fluidically isolating the third port. Manifold 112 further includes, at opposing ends thereof, first and second socket connectors 121 and 123, each defining rearwardly-opening (ie, towards the synthesizer 100 to which is mounted) gas ports 121a and 123a, respectively. Synthesizer 100 includes 25 rotatable arms, each for engaging one of the stopcocks of cassette 110 and to position each stopcock according to a synthesis program, thereby enabling controlled flow through appropriate portions of cassette 110. In FIG. 2, the rotatable stopcocks and the ports 121a and 123a are hidden from view. Manifold 112 and the stopcocks of valves 1-25 are desirably formed from a polymeric material, e.g. PP, PE, Polysulfone, Ultem, or Peek.

Cassette 110 desirably includes a polymeric housing (not shown) having a planar major front surface and defining a housing cavity in which manifold 112 is supported. Cassette 110 includes a first reaction vessel 114 and a second reaction vessel 116. First reaction vessel 114 includes a vessel body 122 defining a reaction chamber 124 and three vessel ports 126, 128, and 130. Vessel ports 126, 128, and 130 are connected in individual fluid communication with valves 7, 8, and 25, respectively. Second reaction vessel 116 includes a vessel body 132 defining a reaction chamber 134 and three vessel ports 136, 138, and 140. Vessel ports 136, 138, and 140 are connected in individual fluid communication valves 9, 10, and 20, respectively. Reaction vessel 114 is sized to be placed within a heating cavity on the synthesizer 100 so that heat may be applied to the reaction occurring in chamber 124. Reaction vessel 116 is able to remain outside of the heating cavity on the synthesizer so that the reactions occurring therein are conducted at room temperature. Additionally, cassette 110 is connectable to an HPLC purification system 105 (in FIG. 1) such that synthesizer 100 is able to direct fluid to the HPLC system and return a purified fluid therefrom back to cassette 110 for additional processing, such as formulation. The return of the purified fluid back to cassette 110 may be provided by connecting an HPLC collected fraction vial 191 vial an elongate conduit 188 to valve 18. Vial 191 also accepts a vent needle therein so as to allow a vacuum applied from synthesizer 100 to draw fluid from vial 191 back to manifold 112. Alternatively, the present invention also contemplates that the purified fluid may be directly received from an HPLC system configured cooperate with synthesizer 100 so as to provide its eluent directly to valve 18.

A first reverse separations cartridge 142 is positioned between manifold positions 4 and 5 while a second separations cartridge 144 is positioned between manifold positions 22 and 23. First separations cartridge 142 is used for primary purification. Second separations cartridge 144 is used for solvent exchange, or formulation. A length of Tygon tubing 146 is connected between manifold valve 21 and a product collection vial 148 in which is dispensed the formulated drug substance. Vial 148 desirably supports a vent needle so as to allow gas within vial 148 to escape therefrom while the vial fills with the product fluid dispensed from cassette 110. While some of the tubings of the cassette are, or will be, identified as being made from a specific material, the present invention contemplates that the tubings employed in cassette 110 may be formed from any suitable polymer and may be of any length as required.

With continued reference to FIG. 2, manifold 112 includes upstanding hollow vial housings 150, 152, 154, 156, and 158 at valves 2, 12, 13, 14, and 16 respectively. Vial housings 150, 152, 154, 156, and 158 include a cylindrical wall 150a, 152a, 154a, 156a, and 158a defining vial cavities 160, 162, 164, 166, and 168, respectively, for receiving a vial containing a reagent for the reaction. For example, in FIG. 2, vial housing 150 will receive a vial containing a solution of K222/KCHO₃, vial housing 152 will receive a vial containing a solution of 2-azidoethyl-p-toluenesulfonate, (TsO ethyl N3 in FIG. 2) vial housing 154 will receive a vial containing a solution of Na-ascorbate, vial housing 156 will receive a vial containing a solution of BPDS, and vial housing 158 will receive a vial containing a solution of ethanol/phosphate-buffered saline (EtOH/PBS) 1:1. Each reagent vial reagent container includes a container body defining an open container mouth and a container cavity in fluid communication with the container mouth and a pierceable septum sealing said container mouth. Each septum is pierceable by the spike, or cannula, projecting from the manifold valve supporting its respective reagent housing. The present invention contemplates that each container body is adapted to be held in slideable engagement with the cylindrical wall of its respective reagent housing in a first position spaced from the respective spike and a second position in which said respective spike extends through the septum into the container cavity. In the second position the container cavity will be in fluid communication with a valve port of its respective valve so that the reagent may be drawn into the manifold and directed as needed for the radiosynthesis method.

Cassette 110 desirably includes an elongate hollow support housing 170 having a first end supported at valve 15 and an opposed second end supporting an elongate hollow spike 172 extending therefrom. Spike 172 is designed to pierce the septum of a water container 174 which desirably provides a supply of water-for-injection for use in the synthesis process. Cassette 110 further includes a plurality of pumps engageable by the synthesis device in order to provide a motive force for fluids through the manifold. Valves 3, 11, and 24 each support a syringe pump 176, 178, and 180, respectively, in fluid communication with the upwardly-opening valve port and each including a slideable piston reciprocably movable by the synthesizer device. Syringe pump 176 is desirably a 1 ml syringe pump that includes an elongate piston rod 177 which is reciprocally moveable by the synthesis device to draw and pump fluid through manifold 112 and the attached components.

Valve 6 supports an elongate hollow housing 182 having a cylindrical wall 182a defining an open elongate cavity 184. The radioisotope, in this example [¹⁸F]fluoride, is provided in solution with H₂[¹⁸O] target water and is introduced at manifold valve 6. Connection of the source of the radioisotope is made to housing 182 prior to the initiation of synthesis. Valve 1 supports a length of tubing 186 extending to a waste collection vial 187 which collects the waste-enriched water after the fluoride has been removed by the QMA cartridge 142. The fluoride will be eluted from cartridge 142, using the K222/KHCO₃ from vial housing 150, and delivered to the first reaction vessel 114, as will be described further hereinbelow.

A length of tubing 188 will be connected to valve 19 and extend to an external purification system 105, while another length of tubing 190 will be connected to valve 18 to return the fluid from the external purification system. The external purification system is desirably an HPLC system (no shown), although other purification systems are contemplated as being suitable for the present invention. Valve 17 supports a luer cap 192 thereon in order to seal the upwardly-opening valve port thereof.

Syringe pumps 178 and 180 are each desirably a 5 ml syringe pump that includes n elongate piston rod 179 and 181, respectively, which are reciprocally moveable by the synthesis device to draw and pump fluid through manifold 112 and the attached components. Movement of fluid through manifold 112 is additionally coordinated with the positioning of the stopcocks of valves 1-25, the provision of a motive gas at gas ports 121a and 123a as well as by a vacuum, such as that applied to port 120 (through vial 135). The present invention contemplates that the motive gas and the water-for-injection may be pumped through manifold 112 so as to assist in operating cassette 110.

Cassette 110 is mated to an automated synthesizer, desirably a FASTlab synthesizer, having rotatable arms which engage each of the stopcocks of valves 1-25 and can position each stopcock in a desired orientation so as to direct fluid flow throughout cassette operation. The synthesizer also includes a pair of spigots, one of each of which insert into ports 121a and 123a of connectors 121 and 123 in fluid-tight connection. The two spigots respectively provide a source of nitrogen and a vacuum to manifold 112 so as to assist in fluid transfer therethrough and to operate cassette 110 in accordance with the present invention. The free ends of the syringe plungers 177, 179, and 181 are engaged by cooperating members from the synthesizer, which can then apply the reciprocating motion thereto within the syringes 175, 178, and 180, respectively. A bottle containing water is fitted to the synthesizer then pressed onto spike 170 to provide access to a fluid for driving compounds under operation of the various-included syringes. Reaction vessel 114 will be placed within the reaction well of the synthesizer and the product collection vial 148 and waste vial 135 are connected. The synthesizer includes a radioisotope delivery conduit which extends from a source of the radioisotope, typically either vial or the output line from a cyclotron, to a delivery plunger. The delivery plunger is moveable by the synthesizer from a first raised position allowing the cassette to be attached to the synthesizer, to a second lowered position where the plunger is inserted into the housing 182 at manifold valve 6. The plunger provides sealed engagement with the housing 182 at manifold valve 6 so that the vacuum applied by the synthesizer to manifold 112 will draw the radioisotope through the radioisotope delivery conduit and into manifold 112 for processing. Additionally, prior to beginning the synthesis process, arms from the synthesizer will press the reagent vials onto their respective cannulas at their manifold valves. Lastly, a conduit 133 is connected to port 120 and spans to a waste vial 135 so that the cavity of vial 135 is in fluid communication with port 120. Waste vial 135 is also pierced by a vent needle 137 which allows gas to pass therethrough but not liquid. A conduit 139 extends from vent 137 to a vacuum port (not shown) on the synthesizer. The synthesis process may then commence.

The present invention further contemplates providing cassette 110 as part of a kit which may be assembled so as to perform a radiosynthesis method. The kit desirably provides cassette 110 with the required lengths of tubing as well as the reagents to be placed in the reagent housings. Additionally the kit of the present invention provides a source of reagents to be provided in second reaction vessel 116 for the click chemistry reaction. The sources of reagents may be provided in one or more vials where one vial contains CuSO₄(aq) and another vial contains βAG-TOCA which may be added to second reaction vessel 116. The kit desirably further provide other reagent containers positioned within the reagent housings of the manifold at the first position so that their respective septums are spaced from the underlying spikes of their respective valves, although these other reagent containers may be insertable into their respective reagent housings. It is further contemplated that reaction chamber 134 may be accessed by disconnecting one or more of the conduit lines connected thereto so as to place the desired reagents therein. The disconnection and connection of those conduit lines, and the delivery of those reagents, is desirably performed under a flow hood providing a suitably clean environment. Likewise, second cartridge 144 may be pre-conditioned under a hood in a suitably clean environment and connected to manifold 112 there as well.

### Example

Cassette 110 may be configured for the production of [¹⁸F]FET-βAG-TOCA, although one of skill in the art will understand that variations in the reagents and operation of the cassette will allow for the production of other radiotracers utilizing either or both of distillation and click chemistry. The automated processes described hereinbelow were all performed using cassette 110 on a FASTlab synthesizer device. First reaction vessel 114 was positioned in the heating well of the FASTlab synthesizer.

The drying of fluorine-18 may be carried out in the first vessel 114 using a known operating sequence, such as that used by the FDG sequence file of synthesizer 100 when operating an FDG synthesis cassette of the prior art. Addition of 2-azidoethyl-p-toluenesulfonate in a solution of MeCN to Reaction vessel 114 is carried out using syringe pump 178 (5 mL syringe), opening valve 11 and adding to reaction vessel 114 through valve 7. The reaction is then heated to 80° C. for 15 min in reaction vessel 114. To distil the solution a low flow of nitrogen (˜100 mbar) is passed into reaction vessel 114 via valve 7, valve 8 is opened and the solution is distilled into Reaction vessel 116 through valve 10, with valves 17-25 being set in open communication so as to allow the exhaustion of the line with a low vacuum (−100 mBar) applied to vial connected to end port 120. The vacuum applied to the vial is provided by a second connection (not shown) between the vial 135 and the synthesizer 110.

TABLE 1

| | 1 (n = 2) | | 2 | | 3 | | 4 | |
|---|---|---|---|---|---|---|---|---|
| Distillation | 6 | min | 4 | min | 6 | min | 1 | min |
| time | | | | | | | | |
| Distillation | 120° | C. | 120° | C. | 100° | C. | 100° | C. |
| temp. | | | | | | | | |
| Approx. | 400 | μL | 200 | μL | 200 | μL | 200 | μL |
| Volume of | | | | | | | | |
| TsO ethyl N₃ | | | | | | | | |
| added | | | | | | | | |
| Volume of | 150 | μL | 100 | μL | 100 | μL | 100 | μL |
| distilled | | | | | | | | |
| [¹⁸F]FEA | | | | | | | | |
| Yield (decay | 52% | | 20% | | 24% | | 17% | |
| corrected) | | | | | | | | |
| Total time to | 36 | min | 34 | min | 36 | min | 31 | min |
| isolate | | | | | | | | |
| [¹⁸F]FEA | | | | | | | | |

Entry 1 in Table 1 above shows the most promising results to date. The [¹⁸F]FEA synthesised on the FASTlab has been used to carry out a click reaction with one of the alkynes designed for Octreotate (AH114667). The click chemistry proceeded as previously found using [¹⁸F]FEA from the thermospray distillation. There appears to be some loss of activity through to the waste bottle and it appears that some activity is trapped within the cassette manifold but this has not been measured to date.

Additionally experiments have been carried out that utilise the FASTlab platform for addition of the click reagents, sodium ascorbate, and bathophenanthroline disodium salt (BDPS). The CuSO₄ and alkyne, AH114667 were added to the reaction vessel 116 prior to the synthesis commencing.

### Experimental Results

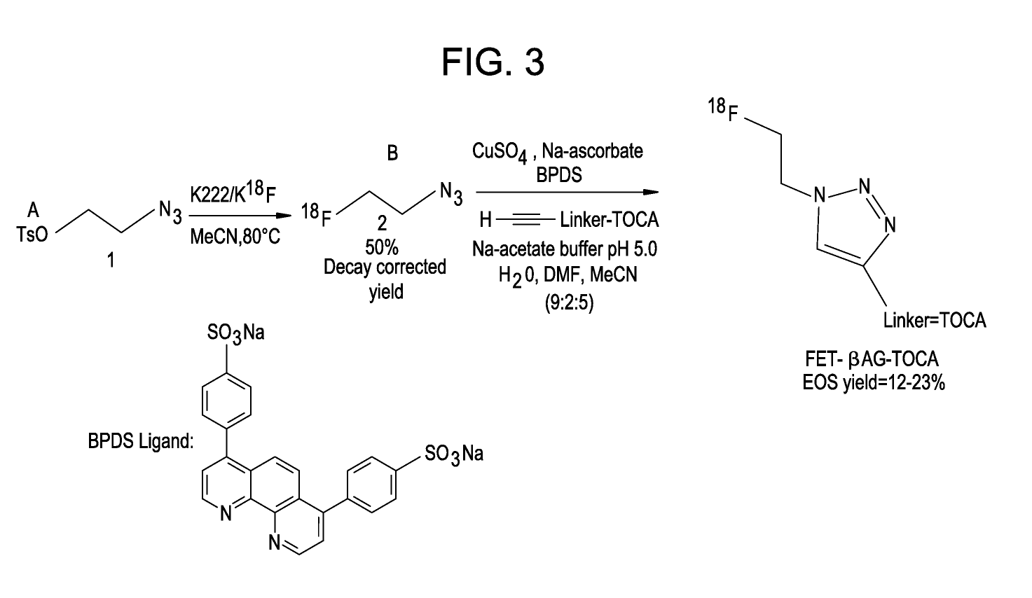

Additional reference is now made to FIG. 3. Before starting the synthesis, K222 (26.6 mM, 1 mL) in MeCN and KHCO₃ (0.1M, 0.5 mL) in H₂O were mixed in a vial (11 mm) and added to the reagent container at valve 2. To a solution of MeCN (2 mL) was added the precursor, 2-azidoethyl-p-toluenesulfonate (‘A’ from FIG. 3) (15 μL) in the reagent vial (11 mm) position valve 12. To a solution of sodium acetate buffer (2 mL, 250 mM, pH 5.0) was added Na-ascorbate (0.29 mM) in a vial (13 mm) and placed in the reagent vial at positioned at valve 13. To distilled water (2 mL) was added BPDS (0.32 mM) in a vial (13 mm) and placed in the reagent vial positioned at valve 14. A solution of EtOH/PBS (1:1) was added to a vial (13 mm) and added to a reagent vial at valve 16. Position 15 includes the water spike connected to a water bag as previously described. The first reaction vessel 114 was attached to the manifold 112 via first, second, and third elongate conduits 194, 196, and 198, respectively at valves 7, 8 and 25, respectively. Second reaction vessel 116 was attached to the manifold 112 via first, second, and third elongate conduits 200, 202, and 204, respectively, at valves 9, 10 and 20, respectively. Before attaching vessel 116 to the manifold, CuSO₄ (13 μmol) in H₂O (25 μL) and βAG-TOCA (3.25 μmol) in DMSO or DMF (50 μL) were added manually into chamber 134 in a clean environment/under a hood. It has been found that there are stability issues with βAG-TOCA that advise against providing it pre-loaded in the reaction vessel (rather than adding it to the reaction vessel at the user's site). Additional hardware components used on the manifold consisted of a QMA cartridge 142 (connected between valves 4 and 5), a tC18 cartridge 144 (connected between valves 22 and 23), an elongate conduit 188 to HPLC module 105 (connected at valve 19), an elongate conduit 190 from the HPLC collected fraction vial 191 (connected at valve 18) and an elongate conduit 146 to the final tracer product vial 148 (connected at valve 21). Position 17 was stoppered with a luer fitting to seal it.

The fluorine-18 was drawn into the activity inlet reservoir (at valve 6) under vacuum and loaded onto the QMA cartridge 142. The K222/KHCO₃ solution was then taken up into syringe 176 (at valve 3) and used to elute QMA cartridge 176 into reaction vessel 114 through valve 7 of the manifold. Reaction vessel 114 was then heated to remove the solvent. The precursor (A) was taken up into syringe 178 (at valve 11) and then added to A (200 μL) and heated to 80° C. for 15 minutes. The distillation was then performed at 120° C., nitrogen was applied to vessel 114 through valve 7, valve 8 was opened to the manifold and valve 10 of vessel 116 was opened to allow the [¹⁸F]fluoroethyl azide to enter, with a low vacuum applied to vessel 116 through valve 20. Following distillation, the Na-ascorbate solution was taken up into syringe 180 (at valve 24), and added to vessel 116 through valve 20. The BPDS was similarly directed through valve 14 to vessel 116. On addition of the reagents, N₂ was applied to the reaction mixture to ensure mixing. After 5 minutes at room temperature the reaction was diluted with H₂O (1.5 mL) and passed through valve 19 to the HPLC module for purification. The product was collected into a vial, diluted further with H₂O (6 mL) and taken up through valve 18 into syringe 2. The diluted product was then subsequently applied to the tC18 cartridge 144 and eluted further with water. A flow of N₂ was passed through the tC18 cartridge 144 to remove any solvents. The tC18 cartridge 144 was eluted with EtOH/PBS (1.5 mL) into the final product vial which contained a PBS solution (9 mL) for final formulation. The solution was then passed through a 0.22 μm sterile filter (PALL, Acrodisc HT Tuffryn Membrane, low protein binding).

### Results and Discussion

The initial step of the synthesis is a nucleophilic displacement of the tosylate group of 2-azidoethyl-p-toluenesulfonate (A) by the [¹⁸F]fluoride anion to yield [¹⁸F]fluoroethyl azide (‘B’ from FIG. 3). On addition of A to the first reaction vessel 114, the solution was heated to 80° C. for 15 minutes. The purification technique used during manual synthesis of [¹⁸F]fluoroethyl azide is distillation, which gives decay corrected yields of 45-50%. Incorporation of distillation onto the FASTlab has been achieved, and gives yields of [¹⁸F]fluoroethyl azide similar to the manual method (45-55%). Distillation was achieved through a gentle flow of nitrogen and heating to 120° C. The solution was then distilled from vessel 114 via the manifold into the second reaction vessel 116 which had a low vacuum applied (−100 mBar). On analysis of the [¹⁸F]fluoroethyl azide, it was found that the material contained traces of 2-azidoethyl-p-toluenesulfonate. To investigate if the contamination of 2-azidoethyl-p-toluenesulfonate would affect the desired click reaction, βAG-TOCA was used under the conditions used previously in the manual synthesis. It was found that the reaction efficiency was unaffected by the presence of 2-azidoethyl-p-toluenesulfonate, and that >98% incorporation of [¹⁸F]fluoroethyl azide was observed after 5 minutes at 20° C. A further observation was that the vinyl triazole by-product, which is found when [¹⁸F]fluoroethyl azide is synthesised manually, was not a significant stable by-product during these reactions (n=5).

The second step in the synthesis sequence was to incorporate the CuAAC reaction onto the FASTlab platform. During stability testing it could be seen that the βAG-TOCA was not stable for >20 minutes in the presence of either Na-ascorbate or BPDS, but was stable for >4 h in the presence of CuSO₄. Thus, this approach was modified, in order to avoid degradation, by adding the Na-ascorbate and BPDS after the distillation of [¹⁸F]fluoroethyl azide was complete. The CuSO₄(aq) and βAG-TOCA were added to reaction vessel 116 before the start of the synthesis. To add the desired quantities of Na-ascorbate (100 μL) and BPDS (100 μL) required careful manipulation of the pressure within the reaction vessels and manifold. The manifold was pressurised initially, followed by vessels 114 and 116. This ensured that no negative pressures were present that could move the solution quickly into the wrong compartment. The Na-ascorbate was then withdrawn from its reagent vial using syringe 180. In doing this process the manifold was filled with the Na-ascorbate solution. Valve 17, which had been sealed with luer fitting 192 on its upstanding port, was then oriented to prevent any solution from backtracking into its reagent vial. The contents of the syringe were then emptied through conduit 133 into the waste vial 135 and then nitrogen was passed via reaction vessel 114 to the syringe (position 24). The Na-ascorbate solution was then passed into reaction vessel 116 through valve 20 with the assistance of the N₂ filled syringe, ie, the N2 was applied through port 121a, and a vacuum was pulled through the waste vial connected to end port 120. The same procedure was then repeated during addition of BPDS. Once both reagents had been added to the reaction mixture a gentle flow of nitrogen was passed into 116 to ensure that the solution was homogenous. Despite the total volume of the reaction increasing to 405 μL (vs the manual method total of about 205 μL), the reaction shows completion after 5 minutes at room temperature. This approach proved successful, during HPLC purification, as [¹⁸F]FET-βAG-TOCA was the major radiolabelled product (>90%). Once the product had been collected from the HPLC purification it was diluted with water and loaded onto a tC18 cartridge ready for formulation. It was found that EtOH/PBS (50:50) could be used to elute the product (1.2-1.3 mL). The isolated end of synthesis yield of [¹⁸F]FET-βAG-TOCA from fluorine-18 (10-100 mCi) was 12-23% (n=7), with a total synthesis time of 80 minutes.

The use of higher levels of fluorine-18 (0.5-1 Curie) was also investigated. Using 1 Curie of fluorine-18 resulted in significant radiolysis of the parent (only 62% parent at T=Om) which is believe due to HPLC purification and tC18 formulation. Although radiolysis occurred during isolation, once the product had been fully formulated (6% EtOH/PBS (10 mL)) it appeared to be stable up to 6 h. During this experiment, the EOS yield after aseptic filtration was 13%. The starting fluorine-18 was then reduced to see enough material could be isolated for a clinical dose, whilst at the same time reducing radiolysis. It was found that starting with 0.5 Curies allowed the isolation of sufficient activity (67-90 mCi (10.3 mL)) and analysis showed 91% of intact parent.

As a result, the present invention has been shown to provide an automatable cassette, and a kit therefor, which may be operated to isolate the final formulated product in EOS yields of 10-18% with radiochemical purity (97%) suitable for routine clinical imaging of neuroendocrine tumors. Those of skill in the art will recognized that the present invention may be modified to synthesize other compounds without departing from the teachings herein.

Additional experiments attempted to add ascorbic acid to the existing HPLC eluent (0.5% w/v), add a sodium ascorbate solution to the HPLC fraction collection vial (5 mg/mL (5 mL)) and elute the tC18 cartridge with a sodium ascorbate/EtOH solution (5 mg/mL/1% EtOH). Unfortunately, due to addition of ascorbic acid to the HPLC eluent, the purification became inefficient, showing very little elution of the stable reagents. Despite the preparative HPLC issues, the radiolysis was reduced and showed 97% parent at T=0 min (FIG. 7). The isolated yield was also unaffected and gave EOS of 14%. To avoid this problem, ethanol was investigated as a replacement for the ascorbic acid. After some optimisation, a suitable solvent system was found (25% MeCN (0.1% HCl), 75% H₂O (0.1% HCl)+0.8% w/v EtOH) which could be used to purify the material at the same time as reducing radiolysis (97% parent T=0 min (n=1)) (Entry 5, Table 2). This resulted in a slightly lower yield and specific activity during this process (EOS 10%, specific activity 32.5 Gbq/μmol), but the results are promising.

TABLE 2
Summary of experimental results starting with >200 mCi of fluorine-18

| | | | Formulated | | | Quantity | Percentage of parent | | |
|---|---|---|---|---|---|---|---|---|---|
| | | | activity | | Specific | of stable | compound at time: | | |
| | Starting | | (~10 ml in 3-6% | | activity | impurity | | T = | T = |
| | activity | | EtOH/PBS) | | (GBq/μmol) | (μg/ml) | T = 0 | 120 m | 240 m |
| 1 | 1 | Curie | 130 | mCi | 481 | 1.24 | 60% | 60% | 60% |
| 2 | 600 | mCi | 67 | mCi | 50.8 | 6.0 | 91% | 91% | 91% |
| 3 | 500 | mCi | 90 | mCi | n.d | n.d | 96% | 96% | 96% |
| 4 | 500 | mCi | 70 | mCi | 86.3 | 3.8 | 97% | 97% | 97% |
| 5 | 500 | mCi | 50.9 | mCi | 32.5 | 7.1 | 97% | n.d. | 97% |

While the particular embodiment of the present invention has been shown and described, it will be apparent to those skilled in the art that changes and modifications may be made without departing from the teachings of the invention. The matter set forth in the foregoing description and accompanying drawings is offered by way of illustration only and not as a limitation. The actual scope of the invention is intended to be defined in the following claims when viewed in their proper perspective based on the prior art.

1. A non-transitory computer readable storage medium with an executable program for operating a synthesis device with a removable synthesis cassette to perform the method of:
performing a chemical reaction in a first vessel at a first elevated temperature;
heating the first vessel to a second elevated temperature to cause distillation;
delivering a distilled reaction product from the first vessel to a second vessel; and
performing a click chemistry reaction with the distilled reaction product in the second vessel.

2. The process of claim 1, wherein said second elevated temperature is higher than the first elevated temperature.

3. The process of claim 1, wherein the first and second vessels are connected to a common manifold.

4. The process of claim 3, wherein said delivering step further comprises directing the distilled reaction product from said first vessel though a portion of said manifold to said second vessel.

5. The process of claim 4, further comprising the steps of:
purifying the click chemistry product, and
formulating a final product from the purified click chemistry product, wherein said purifying step is performed in a purifying device connected to the manifold.

6. The process of claim 5, wherein said purifying device is operated in coordination with said synthesizer device.

7. The process of claim 5, further comprising the step of:
placing click chemistry reagents in said second vessel.

8. The process of claim 1, wherein said second vessel is preloaded with reagents.

9. A cassette for carrying out a radiosynthesis process as directed by an automated synthesis device, said cassette comprising:
a cassette manifold comprising an manifold body including a plurality of valves, each of said plurality of valves defining at least three valve ports, and each said valve of said plurality of valves further comprising a stopcock for placing at least two of its valve ports in fluid communication with each other, each of said plurality of valves including at least one valve port in fluid communication with a valve port of an adjacent valve;
a first reaction vessel comprising a vessel body defining a reaction chamber and three vessel ports, each said vessel port of said first reaction vessel connected placed in individual fluid communication with one of said plurality of valves of said cassette manifold;
a second reaction vessel comprising a vessel body defining a reaction chamber and three vessel ports, each said vessel port of said second reaction vessel connected placed in individual fluid communication with one of said plurality of valves of said cassette manifold;
a first separations cartridge having a cartridge body defining opposed inlet and outlet ports and a cartridge cavity in extending in fluid communication therebetween, said cartridge cavity including a first separation media, each of said inlet and outlet ports connected in individual fluid communication with one of said plurality of valves of said cassette manifold;
a second separations cartridge having a cartridge body defining opposed inlet and outlet ports and a cartridge cavity in extending in fluid communication therebetween, said cartridge cavity of said second separations cartridge including a second separation media, each of said inlet and outlet ports connected in individual fluid communication with one of said plurality of valves of said cassette manifold;
a plurality of pumps, each of said pumps connected in individual fluid communication with one of said plurality of valves of said cassette manifold;
a plurality of hollow reagent housings each individually supported at one of said plurality of valves of said cassette manifold, each said housing defining a reagent cavity in fluid communication with one port of its associated valve;
wherein said cassette further comprises an elongate hollow spike extending within each said reagent housing from the associated valve, such that said reagent cavity is in fluid communication with its associated valve port through the respective hollow spike.

10. The cassette of claim 9, wherein each said stopcock is designed to engage and be rotated by a manipulator arm of a synthesizer device to which the cassette may be mated.

11. The cassette of claim 9, further comprising a hollow support housing having a first end supported at one of said plurality of valves of said cassette manifold and an opposed second end supporting an elongate hollow spike extending therefrom.

12. The cassette of claim 9, wherein said cassette manifold further defines a first and second gas port, wherein said plurality of valves extends between said first and second gas port.

13. The cassette of claim 12, wherein said cassette manifold further defines opposed first and second end ports, wherein said first and second gas ports and said plurality of valves extends between said first and second end ports.

14. The cassette of claim 13, further comprising a sealing cap positioned over one of said first and second end ports.

15. A kit for use in a radiosynthesis process, said kit comprising:
a cassette manifold comprising an elongate manifold body defining a plurality of valves, each of said valves defining at least three valve ports, and each said valve further comprising a stopcock for placing at least two of its valve ports in fluid communication with each other, each said valve including at least one valve port in fluid communication with a valve port of an adjacent valve;
a first reaction vessel comprising a vessel body defining a reaction chamber and three vessel ports, each said vessel port of said first reaction vessel connected placed in individual fluid communication with one of said plurality of valves of said cassette manifold;
a second reaction vessel comprising a vessel body defining a reaction chamber and three vessel ports, each said vessel port of said second reaction vessel connected placed in individual fluid communication with one of said plurality of valves of said cassette manifold;
a first separations cartridge having a cartridge body defining opposed inlet and outlet ports and a cartridge cavity in extending in fluid communication therebetween, said cartridge cavity including a first separation media, each of said inlet and outlet ports connected in individual fluid communication with one of said plurality of valves of said cassette manifold;
a second separations cartridge having a cartridge body defining opposed inlet and outlet ports and a cartridge cavity in extending in fluid communication therebetween, said cartridge cavity of said second separations cartridge including a second separation media, each of said inlet and outlet ports connected in individual fluid communication with one of said plurality of valves of said cassette manifold;
a plurality of pumps, each of said pumps connected in individual fluid communication with one of said plurality of valves of said cassette manifold; and
a plurality of hollow reagent housings each individually supported at one of said plurality of valves of said cassette manifold, each said housing defining a reagent cavity in fluid communication with one port of its associated valve, wherein said cassette further comprises an elongate hollow spike extending within each said reagent housing from the associated valve, such that said reagent cavity is in fluid communication with its associated valve port through the respective hollow spike,
wherein said manifold, vessels, separations cartridge, pumps, and reagent housing are adaptably connectable to perform a synthesis reaction under the control of an automated synthesis device.

16. The kit of claim 15, further comprising a reagent container for each reagent housing, each said reagent container comprising a container body defining an open container mouth and a container cavity in fluid communication with the container mouth, each said container further comprising a pierceable septum sealing said container mouth, each said septum pierceable by the spike of the reagent housing, said container body adapted to be held within its respective reagent housing in a first position spaced from the respective spike and a second position in which said respective spike extends through said septum into said container cavity so as to placed said container cavity in fluid communication with a valve port of its respective valve.

17. The kit of claim 15, further comprising at least one elongate conduit, said at least one elongate conduit adapted to have one end connected in fluid-tight connection with a valve.

18. The kit of claim 15, wherein said second reaction vessel is removably connected to conduits extending between said fluid ports of said second reaction vessel and said associated valves of said manifold.

19. The kit of claim 18, further comprising one or more vials containing contents adaptable to be transferred into said second reaction vessel.

20. The kit of claim 19, wherein one of said one or more vials contains CuSO₄(aq) and another of said one or more vials contains βAG-TOCA.
